(19) United States
(12) Patent Application Publication
(10) Pub. No.: US 2003/0182984 A1
(43) Pub. Date: Oct. 2, 2003

(54) Methods for production of microarrays of biological samples

(76) Inventors: Neil A. Winegarden, Burlington (CA); James B. McNeil, Newmarket (CA)

Correspondence Address: BLACKWELL SANDERS PEPER MARTIN LLP, 720 OLIVE STREET, SUITE 2400, ST. LOUIS, MO, 63101, US

(21) Appl. No.: 10/413,670

(22) Filed: Apr. 15, 2003

Related U.S. Application Data
(63) Continuation of application No. 09/723,417, filed on Nov. 27, 2000.
(60) Provisional application No. 60/237,369, filed on Oct. 4, 2000.

(30) Foreign Application Priority Data
Oct. 3, 2000 (CA) 2,322,086

(51) Int. Cl. G01B 21/00

(52) U.S. Cl. 73/1.79

(57) ABSTRACT

The present invention is directed to methods for supporting the production of microarrays of biological samples using a vacuum manifold and variable pin contact velocity. It relates to methods for preparing the microarrayer for production. The invention includes methods for calibrating a microarrayer print head with respect to a microarrayer components for rapid and safe movement, for testing the spotting accuracy of the microarrayer, for evaluating the efficiency of cleaning procedures for the microarrayer spotting members, and for conditioning spotting members for printing.

### CROSS REFERENCE TO RELATED APPLICATION

This application is a continuation of application Ser. No. 09/723,417 filed Nov. 27, 2000 which application is based on Canadian application serial no. 2,322,086 filed Oct. 3, 2000 for which date priority is claimed.

### FIELD OF THE INVENTION

The invention relates to methods for production of microarrays for biological investigation. In particular, this invention is directed to methods for producing a microarrayer capable of generating a microarray-substrate with a very high concentration of spots.

### BACKGROUND OF THE INVENTION

Modern microarray technologies automate the spotting process using robotics which permits high density spotting of slides, also known as microarray slides, which allows thousands of gene fragments to be analyzed in a single experiment (Schena M, Shalon D, Davis R W, Brown P O. “Quantitative monitoring of gene expression patterns with a complementary DNA microarray”, Science 270, 467-470 (1995); Southern, E, Mir K, and Shchepinov, M, Molecular Interactions on microarrays, Nature Genet. 21, 5-9 (1999)). Each spot constitutes a sample of volume in the nanolitre range, the centers of adjacent spots separated by micrometers.

Typically, a microarrayer has a number of components including: (1) a robotic mechanism for motion; (2) a dispenser assembly including a plurality of spotting members, typically spotting pins for holding and dispensing biological samples; (3) means for replenishing the spotting members with the biological sample; (4) means for cleaning the spotting members; (5) slides for carrying the microarrays; (6) a platform on which the microarray slides are placed; and (7) software to operate the robot mechanism and provide an interface with a user. Samples are typically stored in source plates. It is critical that all these components be calibrated and coordinated in order to produce a suitable microarray slide. In general, source plates may have 1536, 384 or 96 wells where the samples are stored. Spotting members, include pins, which in turn include solid pins, split or quill pins, pin and ring systems, capillaries, or inkjet systems.

The mechanism for dispensing the biological sample typically uses pins as the part of the print head that performs the actual spotting. The preferred approach is a set of pins, typically arranged in a rectangular matrix. The biological samples are loaded into/onto the pins from the source plates, and then dispensed onto slides.

In order to clean the spotting pins preferably the pins are dipped in a cleaning bath (e.g. water). A vacuum or forced air removes liquid from the pins. The tips of pins are generally placed into the holes of a vacuum manifold, either proximate to the opening of the hole, or completely into the vacuum chamber. The chamber is connected to a source of vacuum.

Significantly improved cleaning results when the inlets (holes/apertures) of the vacuum manifold are reduced in cross-sectional area, and the pins are reciprocated or oscillated up and down to create air turbulence, which result in 3 to 5 percent carryover at maximum. However, there is a need for a method to test the result of a cleaning procedure in terms of the carryover.

A microarrayer would typically include a blotting device for blotting liquid from the exterior of microarray spotting members, comprising a blotting surface for drawing liquid from the microarray spotting members when the microarray spotting members contact the blotting surface; and structure for contacting the microarray spotting members with the blotting surface. One variation involves a glass surface as a blot slide, with one or more blot slides held in a blot slide holder. A sufficient number of spots are produced on the blots to remove excess material from the pins that may yield large spots on the array. To achieve operational efficiency and reduce the time required for each run, more than one blot slide may be used, whereby the blot slides require less replacement.

Optimal and safe operation of the microarrayer requires that the pins approach and withdraw from microarrayer components at a reduced speed than when the pins are remote from the components. For example, during printing onto the slides it is necessary to both approach and depart from the slides at a relatively slow speed in order promote optimal spot quality. If the pins approach the slide too quickly they will create “micro splashes” which will disrupt spot morphology. Similarly, if the pins are pulled away from the slide too quickly, then the spots can be pulled in such away that morphology is disrupted.

The “up position”, otherwise known as the first position, for a component such as a slide, defines a spatial position above the component. Beneath the “up position”, the velocity of the print head (therefore the pins) is preferably reduced to a safe limit whether the print head be approaching toward or withdrawing from the component. The “down position”, otherwise known as the second position, is the nearest point to the component that the print head will travel. There is a need for careful calibration to ascertain the up position and the down position (in the coordinate space of the robot) for each component that spotting pins approach in the course of microarrayer operation. For slides, the “up position”, for the pins over the slides should preferably be approximately 2 mm above the “down position”.

### SUMMARY OF THE INVENTION

The present invention is directed to methods for supporting the production of microarrays of biological samples which uses a vacuum manifold and variable pin contact velocity. It relates to methods for preparing the microarrayer for production. The invention includes a method for calibrating a microarrayer print head with respect to a microarrayer component to produce a function with the microarrayer component selected from the group consisting of blotting, spotting, drawing a biological sample from a source plate and spotting member cleaning. As a result of the method, the pins of the microarrayer approach and withdraw from microarrayer components at a reduced speed (within certain distances of the components) than when the pins are remote from the components, resulting in optimal and safe operation of the microarrayer.

In a variation, the invention includes a method for testing the spotting accuracy of the microarrayer. The method comprises producing an array of indicator solution spots with the spotting member, then determining the difference between the actual center position and the expected center position of each spot, where the distance between the actual center position and the expected center position indicates the accuracy of spotting, a lesser difference being indicative of greater accuracy. A computer may be used to determine the accuracy by operating on digitized images of the microarray.

Another aspects of the invention relates to a method of evaluating the efficiency of a cleaning procedure for the microarrayer spotting members, which comprises: printing an array of a primary solution including an indicator; applying the cleaning procedure to the spotting member; printing an array of a reference solution; and then determining the efficiency of cleaning by comparing the primary solution array and the reference solution array to determine the amount of the indicator present in the array of the reference solution array. As a result, invalid results from microarray use due to solution contamination is avoided.

The invention also includes a method for conditioning spotting members for printing comprising delivering a conditioning solution to a source plate using the spotting members until all the spotting members deliver spots of a pre-determined shape and volume.

### BRIEF DESCRIPTION OF THE DRAWINGS

Embodiments of the invention will be described by way of example and with reference to the drawings in which:

FIG. 1: A perspective view of a vacuum manifold connected to a vacuum source and a print head with one printing pin installed in position one.

FIG. 2: Side view of a manifold with micro apertures. One preferably sets the robot up such that the pin tip just passes the opening of the hole at the down position (A), and is reciprocated up to a position a few hundred microns above the opening (B).

FIG. 3: Side view of a print head with a single pin installed approaching a slide, blot slide, or source plate. The pin is not touching the surface of the slide, blot slide or source plate (A), and is moved to touch the slide, blot slide or source plate with the pin slightly lifted out of the print head (B).

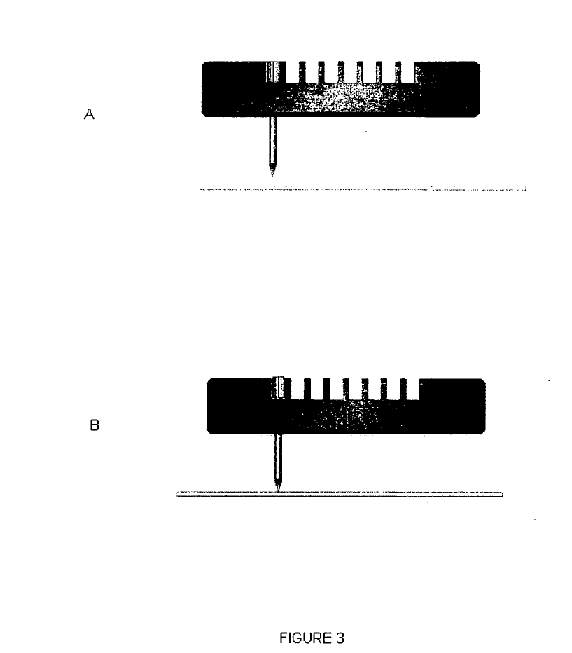

### DETAILED DESCRIPTION OF THE INVENTION

The present invention is directed to methods for producing a microarrayer. The invention may be used with any suitable microarrayer, preferably the SDDC-2 microarrayer (The Microarray Center; Princess Margaret Hospital/Ontario Cancer Institute, Toronto, Canada; Virtek Vision International Inc. and Engineering Services Inc.).

Four preferred aspects of the invention are described here: (1) calibrating the microarrayer; (2) conditioning the pins; (3) testing the reliability of printing; and (4) testing the cleanliness of pins.

Calibration

Calibration of the microarray unit should preferably be performed and then tested before proceeding to any other tests. There are several important areas to examine.

1. X-Y Lateral Coordinates

1) Source plate

The source plate X-Y lateral coordinates are preferably set visually such that the pins are in the middle of the wells. The pins should preferably be lined up at the first well, and then the print head should preferably be moved the appropriate distance to the last well using relative move commands. One would then check how well centered the pins are over that well.

2) Vacuum Manifold

The vacuum manifold must also be precisely aligned. The pins should preferably be able to enter the holes of the manifold without touching the sides of any hole. All positions in the print head should preferably be tested.

2. Z Vertical Coordinates

For all Z-vertical coordinates where the pins are to touch a surface, the Z-value should preferably be set so that the pins just rise out of the print head (around 100 to 200 micrometers past the point at which the pins are touching). This Z value is very important for the following:

1) The source plate

2) The slides carrying the microarrays

3) The blot slides

With each of these different components, the Z-value should preferably be checked at all four corners to ensure that there is a level surface (virtually flat).

Typically, there are different components for which a calibration needs to be performed. These are the vacuum manifold, the water bath, the blot slide, the multi-well source plates, and the slides. Generally, once the machine has been calibrated it will not need to be done again, unless a new component with different physical dimensions is introduced. Thus, after a microarrayer such as the SDDC-2 has been installed, future calibration is often unnecessary.

Vacuum Manifold

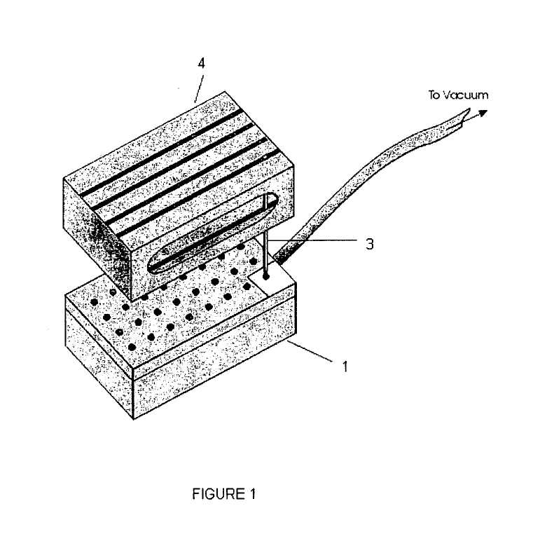

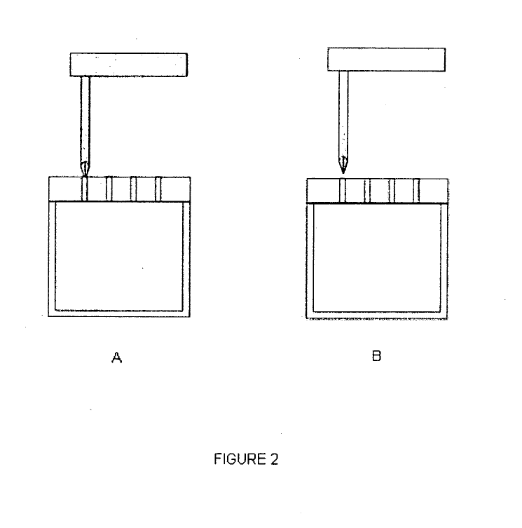

FIG. 1 illustrates a vacuum manifold 1 connected to a vacuum source and a print head 4 with one printing pin 3 installed in the first position of the print head. One spotting pin 3 is shown installed in position one of the print head. FIG. 2(A) is a side view of the print head as it approached the vacuum manifold. The receptacles 5 are numbered and arranged in rows and columns on the print head, with position one in the upper left corner of the print head 4 and the last numbered position in the diagonal opposite corner. The apertures or holes 2 in the manifold are very small and only the very tip of the pin 3 will be able to enter them, as shown in FIG. 2(B). When the robot is installed for the first time, the vacuum manifold 1 is preferably calibrated, and this procedure needs not be repeated under normal circumstances. The reason for any subsequent repetition would be normally due to loss of the calibration settings on the host computer of the microarrayer (due to a hard drive failure, and without backup or other copies of the settings), or relocation of the robot.

The following is a preferred method for calibrating the vacuum manifold by using only one calibration pin.

(1) Place one pin 3 into the upper left corner of the print head 4 (i.e. position number 1);

(2) Using one of the calibration methods described below, maneuver the print head so that the pin 3 is a few millimeters above the manifold 1 and centered in the x and y directions over the hole 2. To check the position, shine a light from a source along approximately the same direction as the line of sight. (If a light source is provided perpendicular to the line of sight, light reflections off the holes in the manifold will cause the hole to appear “shifted” to one side. This light effect will often cause the wrong calibration position to be chosen). Once the pin 3 is properly situated over the first hole 2 of the vacuum manifold 1, then this position is the “up position” for the vacuum manifold 1 for the purpose of the cleaning procedure;

(3) Preferably remove the pin 3 carefully from the print head 4, for example using forceps or a magnet;

(4) Place the pin 3 in the bottom right hole (the last numbered position 7) of the print head 4. Check the calibration here. The pin should be perfectly centered over its corresponding vacuum manifold hole (32nd or 48th position). This helps to determine if the print head 4 is rotated in the x-y plane in relation to the vacuum manifold 1;

(5) If the position looks correct, record the x-, y- and z-coordinates;

(6) Slowly move the print head 4 down (incrementally) until the tip of the pin 3 has just passed into the hole 2 for example in the 32nd or 48th position of the manifold 1. The pin 3 should not be touching the manifold, but the tip should preferably be below the surface of the manifold 1; and

(7) Record this position as the “down position” for the vacuum manifold 1.

Steps (3) and (4) may be skipped if pins 3 are installed in the upper left and the lower right hand corner of the print head 4.

2. Water Bath

Due to the expense of pins, instead of using pins otherwise usable for printing microarrays, less expensive calibration pins may be used. These calibration pins may be used for all calibration types described. The following is a preferred method for calibrating the microarrayer vis-a-vis the water bath.

(1) Move the print head such that the print head is centered over top of the water bath opening with the calibration pins fully out of the water bath. This constitutes the “up position” for the water bath specifying all 3 spatial coordinates. Centering the print head over the water bath is important where the “Oscillate in Water Bath” feature is used during run time for cleaning. If the pins are close to one wall of the water bath, then these will be pushed into the wall damaging them when the robot attempts to oscillate the print head; and

(2) Lower the print head such that the pins are inside of the water bath for the “down position”. The pins should not be touching the bottom of the bath. Instead it should be, for example, about one third of the way into the bath.

3. Blot Slide

In a preferred method, one pin 3 in the upper left print head position should be used for calibrating the blot slide 6. The x- and y-positions should be determined for the blot slide 6 prior to and separate from the z-axis position. If there is more than one blot slide 6, then all the planar positions could be ascertained before the vertical coordinates. The reason for this is that the holder for the blot slide 6 usually has a raised lip, which would interfere with moving the pin 3 close to the blot slide 6 when in the x- and y- position for the blot slide calibration point. The following procedure should preferably be followed.

(1) Place one pin 3 into the upper left corner of the print head 4 (i.e. position number 1);

(2) Obtain the x- and y-position for the blot slide 6 by moving the pin 3 in the upper left print head position over the upper left corner of the slide. The pin 3 is in the upper position;

(3) If there is more than one blot slide 6, then move the print head 4 over the upper left corner of the second slide to determine the x and y coordinates of the upper left corner of the second blot slide, and so on; and

(4) Once the x- and y-positions for the blot slide(s) have been determined, move the print head 4 so that it is over the approximate center of the blot slide 6. Slowly and incrementally move the print head 4 down until the pin 3 is just touching the blot slide 6 (when the pin 3 slightly lift out of the print head 4 a fraction of a millimeter—200 micrometers approximately). This is the “down position” for the blot slide 6. The “up position” should preferably be about 2.5 or more mm up from the “down position”.

4. Slides

The calibration for the slides is done in the same way as the blot slides, however only one slide needs to be measured.

5. 384-Well Source Plate

The source plate calibration needs to be performed for both the horizontal and vertical configurations of the source plate 6 (if both are used). The following procedure should preferably be used to calibrate the microarrayer in relation to the 3 84-well source plates 6.

(1) Place one pin 3 into the upper left corner of the print head 4 (i.e. position No. 1);

(2) Position the print head 4 such that the pin 3 is perfectly centered above the upper left well of the source plate 6 (not the A1 position necessarily, but the upper left). The pin 3 should be about 2 mm above the opening of the well;

(3) Remove the pin 3, and move it to the bottom right hole of the print head 4 and check the position over the source plate 6 again. Once the print head 4 is centered, this is the “up position” for the source plate 6. Accuracy is important here due to the small diameter of the holes of the 384-well plate 6; and

(4) Slowly move the print head down until the pin is just touching the bottom of the source plate 6 (the pin 3 being lift out of the print head 4 by approximately 200 micrometers). This is the “down position” for the source plate 6.

6. 96-Well Source Plates

96-well source plates are calibrated in essentially the same manner as 384-well plates. In fact, the calibration is a little easier due to the large well size, thus less accuracy is required (although extreme accuracy should always be the goal). The only real difference here is that when moving the pin from the first hole in the print head, the pin is not moved to the last (bottom right) position in the print head. This is due to the different spacing of 96- and 384-well source plates. 96-well source plates limit the user to occupying every other hole of the source plate. Thus, the pin should be moved to the position, which is one up, and one over from the last hole. This is the last position that can be occupied when printing from 96-well plates. The rest of the calibration is the same as for 384-well plates. Other plates, such as 1536 - well source plates are calibrated in a similar manner.

Testing Accuracy of the Microarrayer

Microarrays are synthesized through the deposition of sample material (for example DNA) placed at specific addresses onto a slide substrate. The intrinsic characteristics of microarrays are that they possess a large number of samples confined to a small space yielding well-ordered arrays with a minimum of overlapping material. Two factors have been identified that affect the maximum permissible array density. These are the size of the spots produced and the accuracy of the arrayer. The accuracy of an arrayer affects the reliability at which spots are placed at position determined by controlling software. The greater the accuracy, the more precise is the deposition of spots, precluding the creation of overlapping spots. Well-ordered arrays also facilitate the analysis of the resultant images. It is therefore desirable that the deposition of samples onto substrates yields well-ordered arrays. The size of the samples spotted on the slide substrate is affected by a variety of factors including, the nature of the deposition pins, the constituents of the material spotted and the chemical nature (i.e. hydrophobicity) of the slide.

The following describes one embodiment of the invention in the steps taken to evaluate the accuracy of array printing:

(1) Prepare the slides by spotting on these an appropriate indicator (preferably fluorescent dye or DNA samples. Using a salt solution to print arrays during this test is not recommended. It is after evaporation of the aqueous that the solute is observable. Initial conditions, such as humidity, salt concentration and surface characteristics of the substrate will affect the distribution of the salt over the spot. Because of the chemical nature the solution, the distribution of salt is not uniform over the spotted area. Frequently, the final resting position of the salt does not correspond to the initial topology of the spotted salt solution.). The samples spotted must be such that an image can be obtained. If DNA samples are used, the DNA spotted may be either labeled prior to deposition or labeling of DNA may be accomplished after spotting by a number of methods (see below);

(2) From the image, identify the center of each spot. This can be estimated by the intersection points of a number of lines of greatest length which bisect the area covered by the spot. Alternatively, if an image of the array is digitized, the center of a spot may be determined by numerically-based methods. Such methods as first moment and Gaussian interpolation are well known to persons versed in the art;

(3) Determine the expected center of each spot with reference to the observed center position of a preceding spot. For each spot on the outer edge of the array, use the spot following the spot as the reference. As an alternative, construct and overlay a grid over the actual points, where the grid points are separated by constant distance in the x and y direction as determined by the robotic system (the inter-pin distances). The first and last grid points (a diagonal pair) are superimposed on the actual centers of the first and last spots (or closest point thereto in the case of the latter). All the expected centers are thus defined as grid points; and

(4) Measure the difference between the observed and expected spot centers for all adjacent spots and sum the absolute value of the differences in both the x and y direction for all rows and columns. [Steps (2) to (4) can be automated by software which heuristically determines the spot centers and sums the distances from the expected to the actual spot centers. The precise locations of these are determined using the same approach as the instrumentation which processes the hybridized samples.]

In the case of the first approach of step (3) above, since there is no ‘true’ reference point on the slide from which all the spots are produced, the center of each spot is measured relative to the previous spot. In this way each spot is measured relative to all other spots. The more ordered the array the lower the sum of the center-to-center differences.

It is obvious to the person in the art that this approach is extensible to a measure of deviation based on the two-dimensional distance (instead of projected x or y distance) between the centers of the expected and the actual spots are summed.

The equation below provides a numerical value for the deviation from expected positions.

It is the sum of all differences between expected and observed distances from the center-to-center of adjacent spots in the x direction.

Σ_{∀x}_{ᵢ}|Δxᵢ−Dxᵢ|

where xᵢ is the i-th pair of adjacent spots in the x direction (3 roughly collinear spots would result in 2 pairs of adjacent spots) as printed;

Δxᵢ is the projected distance on the x-axis between the center of the two adjacent spots of the i-th pair; and

Dxᵢ is the expected distance between the i-th spot pair (as determined by the software driving the robot arm of the microarrayer as the inter-pin distance in the x direction).

The same value would be computed for the y direction. The sum of the two values for deviation is a further estimate taking into consideration both dimensions.

The maximum value allowable for any deviation will depend on the type and nature of array printed. This value can help to determine the lower limit of center-to-center distance for an arrayer. Ideally one would wish to be able to use this value to determine the minimum allowable center-to-center distance. As mentioned above, other factors also affect array density and their consideration would also be required. Such a value could be useful during comparison of arrays. The smaller the deviation the more accurate the arrayer.

If the summed deviation value is normalized by dividing the sum of differences by the number of adjacent pairs, then an accuracy value of 100 or less (for each direction and not a sum of x and y deviation values) would indicate a well ordered array, each pair of spots being, on the average, out by 10 microns or less from the expected. A value of 400 would reflect an array that is poorly ordered. Misalignment will effect greater difficulty in analysis due to the overlapping of spots and during setup of the spot quantification templates.

Testing Cleanliness of Pin Members

In order to avoid cross-contamination of microarrays, the pins must be cleaned thoroughly and properly after printing. The purpose of pin cleaning is to remove nucleic acids from the dispensing pins prior to deposition of subsequent samples on the microarray slides. Pin cleaning typically involves several cycles of wash followed by the application of vacuum to remove the wash material.

Dispensing pins, when inserted into samples, acquire a small aliquot of material and then transient contact with a slide substrate leaves behind a small amount of material. The pins typically acquire approximately 100 nanolitres (0.1×10⁻⁶ liters). This is sufficient material to print about 250 spots (when done so under appropriate conditions of humidity and temperature) with an approximate volume of 0.5 nanolitre (5×10⁻¹⁰ liters) or less each.

The microarrayer produces arrays, which when used in an experiment, can yield images that include spot intensities ranging from 0 to the maximum as capturable by the image reader, typically 2^{ilen}−1, where ilen is the number of bits in the binary representation of the storage for intensity value. In the case of the SDDC-2, the maximum intensity value is 65,535 (2¹⁶−1). This maximum intensity value corresponds to a saturation point for the image reader. Any signal intensity above this will still read as the maximum intensity, i.e. 2^{ilen}−1 (2^{ilen} on some systems).

A fraction of any material that yields a high intensity spot (for example, sample i, represented as sᵢ), that remains on the pin after cleaning, may contribute significantly to the intensity of spots printed subsequently (samples sᵢ₊₁, sᵢ₊₂, etc.) using this pin. The average spot intensity for a typical microarray experiment is about 2000, with less than 0.1% of spots yielding the maximum intensity of 65538. If, as a general rule, 10% of previous material ‘carries over’ to subsequent samples, then a high intensity spot (maximum intensity) may contribute as much as 6500 units of sample to the next sample. Given that the average spot intensity is 2000 units, an additional 6500 units to the (i+1)st spot will not permit accurate evaluation of most (i+1)st samples. The same sample sᵢ would also contribute at least 650 units to sᵢ₊₂ as well.

A source plate will be preferably used to print the slides. This plate will be printed several times to develop a fairly large scale array (say about 5 to 10 spots per row and column). For each method described below, an indicator solution is used that yields a greater spot intensity than that generated by a reference or blank solution and the slide substrate background. The pin cleaning evaluation procedure includes the following variants:

1) Qualitative Evaluation of the Efficacy of Pin-Cleaning Using a Salt Solution

Alternate printing of a salt solution and a water blank samples, with a pin-cleaning step between the two sample sets obtains an approximate evaluation of pin cleaning. A solution of salt (3×SSC for example), when dried on the slide, leaves behind an easily observable residue. The test involves the printing of salt on slides, preferably followed by water after execution of a pin cleaning routine. Incomplete removal of salt from the pins (inefficient pin cleaning) would yield detectable quantities of salt in spots derived from the water blank sample. The system is sufficiently sensitive to detect 5% cross contamination. Examination of the slides would qualitatively reveal the degree of carry over of the salt material. This method permits quick evaluation of new innovations and development, and in particular those involving pin cleaning.

2) Method (Protocol) Used to Evaluate Test Results and Quantify the Efficiency of Pin Cleaning for Nucleic Acids

Because of the difference in the chemical and physicals properties of salt and nucleic acids, a test specific for the latter was developed to quantitatively examine the efficiency at which nucleic acids are removed from the pins. Execution of the test is similar to that described above for salt solution. Cycles of printing occur with alternating samples of DNA followed by the blank (either water or salt solution) with a pin-cleaning step between the two. The blank sample consists of a liquid medium, preferably the same solution in which the DNA samples are placed (for example 3×SSC). This is to provide a medium for any DNA not removed during the wash and remaining on the pins. The efficiency at which the pins are cleaned of DNA is determined by an accurate measurement of the amount of DNA in the ‘DNA’ and ‘blank’ spots.

Two methods are used to quantify the relative amounts of DNA present in the DNA and blank spots. One involves direct labeling of DNA on the slide. The DNA polymerase, terminal transferase, catalyzes the addition of nucleotide triphosphates to the 3′-hydroxyl termini of DNA molecules yielding a homopolymeric or heteropolymeric tail. The preferable addition, to the slide under a coverslip, of a fluorescently labeled dNTP-derivative (nucleotide triphosphate substrate) with terminal transferase in the presence of an appropriate divalent cation will specifically label the DNA. Subsequent of DNA labeling, the slide is washed to remove unincorporated dye from the surface of the slide and to prepare the slide for quantification of spot intensities. Using one of a variety of fluorescent readers available does this. Such readers are accompanied by appropriate software, which provides this information. Intensity is measured via software, and calculated as the integrated or average intensity of the pixels within the region defined as the spot. The relative intensity of the spots derived from the DNA and blank samples will indicate the efficiency at which the pins were cleaned of DNA. The percentage efficiency of pin cleaning is preferably defined as:

$$\frac{{I}_{DNA} - {I}_{Background}}{{I}_{Blank} - {I}_{Background}} * 100$$

where

I_{DNA}=Intensity of DNA sample spots;

I_{Blank}=Intensity of Blank sample spots; and

I_{Background}=Intensity of the background (background is calculated by obtaining an average intensity for areas subjected to labeling reagent but devoid of spots).

A second method, developed to examine the efficiency of pin cleaning involving DNA uses indirect labeling and a hybridization step. Since this test faithfully mimics actual experimental conditions, it more accurately evaluates the pin cleaning protocol. The steps are preferably as follows:

(1) DNA complementary to the DNA sample is labeled using standard protocols. This may involve a number of different methods and templates well known to a person knowledgeable in the field;

(2) The labeled material is then placed on the slide and hybridization between complementary DNA sequences occurs; and

(3) Determine the intensity over the ‘DNA’ and ‘Blank’ spots calculating the efficiency of pin cleaning as described above. The amount of labeled material observed is proportional to the amount of complementary material on the slide.

If the cleaning is not being performed as expected the whole process need to be repeated.

Pre-conditioning the Spotting Pins

Pre-conditioning the spotting pins is important in order to achieve optimal spotting performance, especially when the pins are new, or have not been used for an extended period of time (at least weeks). Once properly preconditioned, normally the pins will not require a great deal of subsequent pre-conditioning on subsequent days.

This following protocol is used for new pins, and also before each run to ensure the pins are printing properly.

1) If the pins are new, it is recommended that these be first inspected under a microscope (dissecting scope) for structural damage.

2) Place one or more clean blot slides onto the blot slide holders.

(a) The number of blot slides required depends on the number of pins to be conditioned. 16 pins can be conditioned preferably using only one blot slide, 32 or 48 pins requires two blot slides. The constraint is the size of the slide, number of spots etc.

(b) In order to clean the blot slides one will preferably do the following:

(i) While preferably wearing powder-free gloves, scrub the slides thoroughly using soap and water, preferably with a lab grade soap;

(ii) Rinse preferably the slides thoroughly under tap water, and then either distilled or Milli-Q water;

(iii) Rinse the slides with 70% ethanol; and

(iv) Dry the slides, possibly placing the slides in a slide rack and dry in an incubator at about 37 ° C. to speed up drying.

3) Place about 2 to 5 slides on the slide platform. Preferably use coated slides for this. For example, Silylated microscopes slides from CEL Associates (www.CEL1.com) may be used. Two slides are generally sufficient, however more may be used to fully test the spotting performance.

4) Deliver preferably to a 384 well plate with about 5 μl of 3×SSC per well. One example is to use Polyfiltronics 384 well 80 μl V-bottom polypropylene collection plates.

5) After preferably delivering 3×SSC into each of the wells, spin the plates in a centrifuge at about 500 rpm for approximately 2 minutes to pull all the liquid to the bottom of the wells.

6) Define a run as follows:

(1) 384 well source plates

(2) number of pins to be used

(3) 20 spots per column and 20 spots per row

(4) 20 duplicate spots

(5) number of slides to be used

7. Do a run. The program is set to print out 20 by 20 sub-arrays, where after each dip, the print head puts 20 spots per slide per pin. It is important to use a normal spotting routine without washing for example because it appears that the constant wash and vacuum after each printing step actually helps to condition the pins.

8. Repeat the run if not all of the pins have printed. Generally, if the pins have been used within the past few days, a single run will be sufficient; however for new pins, or pins which have not been used for a long period of time, this may take up to 4 runs depending on the set of pins. Once all pins are printing, they should continue to work well.

9. If certain pins do not print after about 4 runs through this above procedure, preferably do the following:

(a) Remove the pins that are not printing and inspect them under a dissecting microscope for damage. In general, damaged pins cannot be repaired and must be replaced.

(b) If the pins are instead clogged with material, they will need to be cleaned. To clean the pins, preferably use either a micro-cleaning solution, for example available from Telechem, or do a simple sonication of the pins in water. Often, even if the pins do not look dirty, sonication can improve spotting performance.

A number of guidelines should be followed for proper execution of the pre-conditioning procedure:

It is preferable to have moderately high humidity for pre-conditioning and for further spotting. Moderately high humidity is about 50-60%; in any case, the humidity should preferably not be higher than about 65%, and no lower than about 30%. At very low humidity, it is very difficult to get the pins to spot. At very high humidity, two factors come into play. Firstly, the very high humidity causes spots to run together. The high salt content of the spotting solution causes water to accumulate, and thus the spots grow in volume and size. Secondly, the high humidity causes the air bushing used to “lubricate” the pin method to lose its effectiveness. For this reason, the pins would no longer glide in the print head as easily as they should, causing both increased pin wear, and loss of spotting performance.

The pins should not be handled by the tips. In addition, preferably never touch the tips of the pins with bare hands. Preferably do not handle the pins at all with bare hands. The oils from the skin cause problems with the pins.

Once all the pins are printing properly, preferably return the pins to the same place in the print head. Certain pins print better in particular positions in the print head.

It may be necessary to print for hours during pre-conditioning before every pin starts to print properly for the first time. To ensure that the pins will print well after having been conditioned, preferably store the pins in a cleaned condition. Preferably clean thoroughly and inspect the pins prior to storage for any period of time.

Testing the Reliability of Printing

It is important to test the reliability of printing by the microarrayer. This will also involve a breaking in of the pins so that such are ready to print on delivery. As a general rule, the pins require a time of wear in before they print reliably. The following test will involve printing with all the pins being supplied to the customer preferably using 3×SSC salt solution in a 384 well source plate.

It will likely take several rounds of printing to get a reliable result. This test will serve several functions.

1. Ensuring the pins are up to specifications.

The suppliers of pins usually check their pins visually under a microscope and with various other measuring instruments, but such testing are not known to extend to such as to ensure they work as intended. We can provide this level of testing, covering spot quality, size, volume, et cetera.

2. Testing source plate calibration.

If the source plate coordinates are not calibrated properly, the resultant spots that are made will be large due to the pins rubbing against the edges of the wells.

3. Testing calibration on blot slide.

If the vertical Z-coordinate for the blot slide is not set properly, the blot slide will not print properly, and hence the pre-blotting will not perform as expected. This can be judged by examining the blot slides after each run to see how the spots look.

4. Testing calibration for chips.

Again, if the Z-coordinate for the chips is not properly selected printing on the slides will not be effective. Similar to the blot slide, this is judged qualitatively by examining the spots on the slide.

It will be appreciated that the above description relates to the preferred embodiments by way of example only. Many variations on the apparatus for delivering the invention will be obvious to those knowledgeable in the field, and such obvious variations are within the scope of the invention as described and claimed, whether or not expressly described.

All patents, patent applications (including the Canadian patent application (filed Aug. 16, 2000) and U.S. patent application (filed Aug. 17, 2000) entitled “Devices and Methods for Producing Microarrays of Biological Samples”) and publications referred to in this application are incorporated by reference in their entirety.

1. A method for calibrating a microarrayer print head with respect to a microarrayer component, the print head including a spotting member having a first end and a tip defining an elongate axis therebetween, the calibration permitting the spotting member to produce a function with the microarrayer component selected from the group consisting of blotting, spotting, drawing a biological sample from a source plate and spotting member cleaning, the method comprising:
(a) guiding the print head to a first location in which the spotting member is spaced apart from the component so that the spotting member axis is transverse to the component;
(b) calibrating the first location as a microarrayer first position;
(c) guiding the print head along the axis to a second location proximate to the component wherein in the second location the spotting member is capable of producing the function with the second component selected from the group consisting of spotting member blotting, spotting, drawing a sample from a source plate and spotting member cleaning; and
(d) calibrating the second location as a microarrayer second position.

2. The method of claims 1, wherein the microarrayer component comprises a plate defining a plurality of fluid flow channel members formed through the plate, each channel member defining an inlet and an outlet in fluid communication.

3. The method of claim 2 wherein the spotting member comprises a first pin received in the print head and (i) in the first position the spotting member axis is transverse to the center of a first channel member inlet so that the tip is proximate to the center of the inlet.

4. The method of claim 3, wherein a second pin is received in the print head and laterally spaced apart from the first pin so that the second pin axis is transverse to the center of the inlet of a second channel member of the plate.

5. The method of claim 3, wherein the first pin is received in a first position on the printhead, and a second pin is received in a last position on the print head.

6. The method of any of claims 1 to 3, wherein the microarrayer component comprises a vacuum manifold and the tip of the spotting member in the first position is spaced about 100 micrometers apart from the vacuum manifold.

7. The method of any claims 1 to 3, wherein the microarrayer component comprises a source plate selected from the group consisting of a 1536-well source plate, a 384-well source plate, and a 96-well source plate, and the tip of the spotting member in the first position is spaced about 2 millimeter apart from the source place.

8. The method of claim 1, wherein the spotting member is in contact with the microarrayer component when the print head is in the second position.

9. The method of claim 1, wherein the component comprises a first end and a second end defining a component axis therebetween and the spotting member axis is coaxial with the microarrayer component axis.

10. The method of claim 9, wherein a plurality of spotting members are received in the print head and in the first position the spotting member is received in the last position on the print head.

11. The method of claim 2 wherein the first spotting member is received in a first position on the print head and a second spotting member is received in a last position on the print head.

12. The method of claim 1, wherein the microarrayer component is selected from the group consisting of a vacuum manifold, a 1536-well source plate, a 384-well source plate, a 96-well source plate, a blot slide, and a microarray slide.

13. The method of any of claims 1 to 5 and 8 to 12, wherein the print head is guided by a processor.

14. The method of claims 1 to 5 and 8 to 12, wherein the print head is guided by a joystick means.

15. The method of claim 1 wherein the function is dispensing.

16. The method of claim 15 wherein the dispensing function is blotting.

17. The method of claim 16 wherein the dispensing function is spotting.

18. The method of claim 1 wherein the function is holding.

19. The method of claim 18 wherein the holding function is drawing a biological sample from a source plate.

20. The method of claim 19 wherein the holding function is spotting member cleaning.
